(19) United States
(12) Patent Application Publication
(10) Pub. No.: US 2021/0071718 A1
(43) Pub. Date: Mar. 11, 2021

(54) Frictionless Clutch

(71) Applicant: Ted Alan Scarborough, Comanche, TX (US)

(72) Inventor: Ted Alan Scarborough, Comanche, TX (US)

(21) Appl. No.: 16/563,903

(22) Filed: Sep. 8, 2019

(51) Int. Cl. F16D 3/26; F16D 3/50; F16D 3/02

(52) U.S. Cl. CPC F16D 3/26; F16D 3/02; F16D 3/50

(57) ABSTRACT

In most applications in the power transmission field, a means must be provided to repeatedly engage and disengage a powered spinning shaft from a receiving shaft. The invention introduces a simple new way of doing so by taking advantage of a common universal joint's inability to continue transferring torque beyond a certain angle. When the angle is reached, the universal joint locks up and acts as a simple pivoting arm. This pivoting arm is used to transfer the torque to a receiving shaft which is also equipped with a pivoting shaft inserted into the elongated tube of the universal joint (FIG. 4). At lesser angles, the universal joint tube simply spins around the receiving shaft's pivoting shaft, producing no movement of the receiving shaft (FIG. 3). This mechanism accomplishes a clutching and declutching action with no friction wearing surfaces, thus a frictionless clutch.

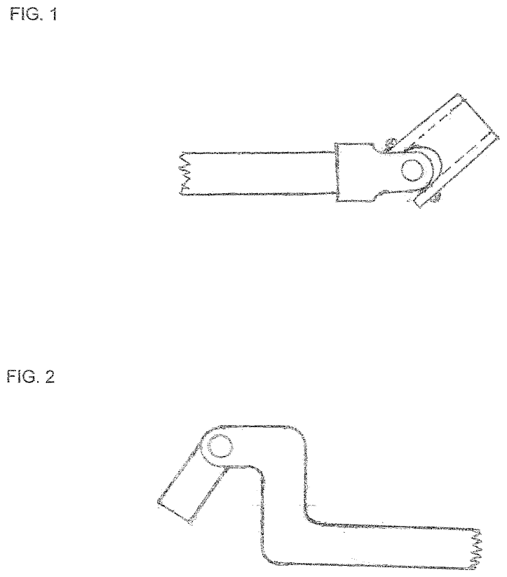

The invention is a clutch system which engages and disengages without any friction between a powered input shaft and an output shaft, as illustrated by FIG. 1 through FIG. 4 in the Drawings.

FIG. 1 is an input shaft, consisting of a driveshaft with an attached universal joint. One end of the universal joint is attached to the shaft and the other is elongated to act as a hollow tube.

FIG. 2 is an output shaft, consisting of a driveshaft shaped as shown with a pivoting shaft attached as shown.

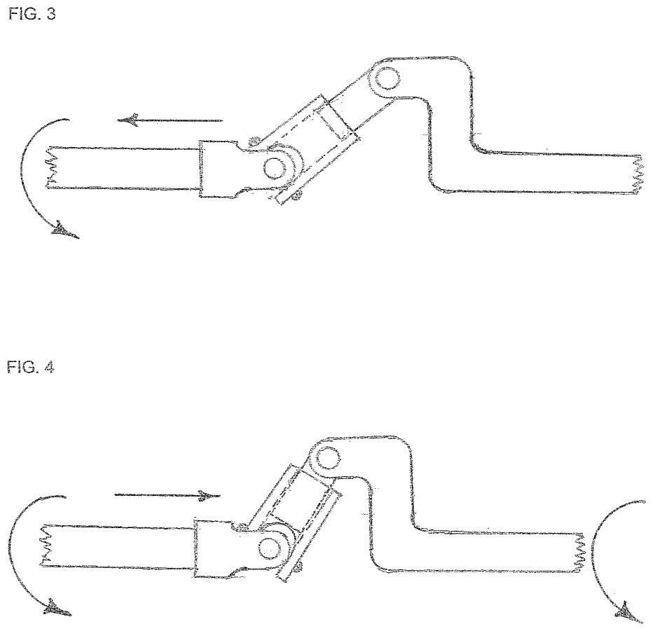

FIG. 3 shows the input and output shafts aligned on the same axis with the pivoting section of the output shaft inserted into the elongated hollow tube of the universal joint on the input shaft. In this illustration, the input shaft is positioned laterally along the axis such that the universal joint hollow tube and the pivoting shaft are at an approximately 45 degree angle with regard to the axis of the input and output shafts. In this position, the powered input shaft will spin without moving the output shaft, thus in a disengaged or declutched condition.

FIG. 4 shows the same arrangement as described above in FIG. 3, except that the input shaft is positioned laterally along the axis such that the universal joint hollow tube and the pivoting shaft are at an approximately 60 degree angle with regard to the axis of the input and output shafts. In this position, the universal joint will exceed its ability to continue revolving in its usual capacity and will lock up, resulting in the universal joint hollow tube and the pivoting shaft moving together along with the output shaft, thus in a fully-engaged or clutched condition.

The patent is for the system as described above. Lateral movement of the input shaft along the axis and dynamic balancing of the moving parts can be accomplished by commonly used means not a part of the patent.

The invention covered in this patent is for a system which accomplishes a clutch connection with no wearing friction components. Advantages:

1) Elimination of replacement of friction wear surfaces.

2) System can be scaled from very small devices to large industrial applications.

3) Simple minimal components keep manufacturing costs low.
